(19) United States
(12) Patent Application Publication
(10) Pub. No.: US 2007/0200716 A1
(43) Pub. Date: Aug. 30, 2007

(54) Personal safety alarm device and method

(75) Inventors: Andreas R. Haase, Plantation, FL (US); Michelle Beauchamp, Hollywood, FL (US)

Correspondence Address: LERNER GREENBERG STEMER LLP, P O BOX 2480, HOLLYWOOD, FL, 33022-2480, US

(73) Assignee: Concord Camera Corp., Hollywood, FL (US)

(21) Appl. No.: 11/706,521

(22) Filed: Feb. 15, 2007

Related U.S. Application Data
(60) Provisional application No. 60/776,492, filed on Feb. 24, 2006.

(51) Int. Cl. G08B 13/00; G08B 1/00; G08B 23/00

(52) U.S. Cl. 340/574; 340/573.1; 340/309.16

(57) ABSTRACT

A personal safety alarm device is provided that is of specific applicability to children. The personal safety alarm is integrated into a watch to be worn by a child.

### CROSS-REFERENCE TO RELATED APPLICATION

The present application claims priority from co-pending provisional patent application Ser. No. 60/776,492, filed on Feb. 24, 2006, entitled PERSONAL SAFETY ALARM DEVICE AND METHOD.

### BACKGROUND OF THE INVENTION

1. Field of the Invention

The invention relates to a personal safety alarm device and method and more particularly a personal safety alarm device that is wearable by a child and method for using the same.

2. Description of the Related Art

A number of child safety devices are known. There are crime prevention buzzers in Japan in the form of a key holder or neck strap. These devices include a pull-pin that is pulled from the device to activate a buzzer and which can be thrown away, thus preventing an attacker from replacing the pin and silencing the alarm. However, the devices are an extra thing for a child to carry and/or remember, and which serve no other purpose.

Additionally, there are cell phones that are sold as emergency phones for a child. Phones such as the FIREFLY mobile phone by FIREFLY MOBILE include a few preprogrammed buttons including an emergency 911 button to connect the child to emergency assistance. However, such phones do not include buzzers or alarms that deter an attacker. Additionally, such phones are easily forgotten by children, and taken from a child, by an attacker.

ALARMWEAR.COM produces products including jackets, backpacks and fanny packs that can be carried by a child and which include an alarm device designed to draw attention to the child when activated. To activate the alarm, a small ring on the alarm device is pulled, pulling a pin free of the device. The ALARMWARE alarm is deactivated by reinsertion of the pin. However, such jackets and packs will routinely be forgotten by a child, or intentionally not carried or worn. Additionally, such jackets and packs can be easily removed from the child by an attacker.

LEGOLAND has introduced a WIFI KIDSPOTTER that can be used by a parent to locate a child within the theme park. Other such devices exist for tracking and/or geographically locating a child, such as the GTX GPS enabled footwear, including a GPS chip in a shoe. IONKIDS child monitoring system includes a GPS wrist tag worn by a child. WHERIFY makes a GPS locator wristwatch worn by a child. In the WHERIFY system, a user presses two outer buttons on the front face of the watch to initiate a 911 call for assistance. Additionally, the WHERIFY device is electronically locked onto the wrist of the child, and must be unlocked by the parent locally or remotely using, among other methods, a remote keyfob transmitter. These devices do not include an alarm to draw attention to the child and deter an attacker during the initial attack.

Further, certain devices have been described in U.S. patents. For example, U.S. Pat. No. 4,591,836 to Feigenblatt, Jr. et al., discloses a battery operated panic alarm wristwatch having a watch and a band, and audio transducer for producing an audio signal. In Feigenblatt, Jr., a magnetic switch for activating the battery is disposed in the band and a hook and loop fastener is used for keeping the band closed. The use of hook and loop fasteners makes it easy to “yank off” the watchband during an attack, such that when the watchband is opened, a switch is closed and an alarm sounds. However, by its very nature, such a device does not maintain the activated alarm with the wearer, in order to attract attention to the wearer.

U.S. Pat. No. 5,574,433 to Bahcall discloses a personal security alarm combined with a wristwatch including a single exposed activation button on a large surface thereof, to be easily activated by a person's finger or face; a reset button is hidden on the underside of the device to require removal of a buckle fastener before resetting can be done.

U.S. Pat. No. 5,420,570 to Leitten et al., discloses a manually actuatable wrist alarm having a high intensity sonic alarm signal. In one embodiment, the personal alarm of Leitten is incorporated into a wristwatch with the alarm components arranged thereon. Leitten discloses that the alarm may be activated or deactivated by manually actuating an actuator, such as a switch or plurality of switches, in a particular sequence. Leitten additionally discloses in col. 5, lines 10-14, two push button switches 18, 20 respond to a simultaneous depression by the wearer for actuating the wrist alarm. In the preferred embodiment of Leitten, switches 18, 20 are located on opposite sides of housing 14 for easy access.

U.S. Pat. No. 6,285,289 to Thornblad discloses a smoke detector wrist kidnapper alarm featuring a silent security alarm feature, a smoke detector alarm feature and, optionally, the feature of providing the time of day to the wearer, as a further incentive for a child to wear the device.

U.S. Pat. No. 6,310,539 to Rye et al., discloses a unit including a normally open switch embedded in or affixed to an item that can be easily carried by an individual, such as in a watch. Rye discloses that the panic button is associated with an RF transmission source, which, when activated by the operation of the panic button transmits a coded RF signal.

U.S. Pat. No. 5,923,255 to Vahdatshoar discloses a child danger-signaling device for alerting guardians when a child presses a danger switch. Vahdatshoar discloses a transmitter worn by a child and a receiver carried by a parent with an attached key for disarming the transmitter.

What is needed is a personal safety alarm device appealing to children. What is additionally needed is a personal safety alarm device easily operable by children, when needed.

### SUMMARY OF THE INVENTION

It is accordingly an object of the invention to provide a personal safety alarm device and method, which overcomes the above-mentioned disadvantages of the heretofore-known devices and methods of this general type.

A personal safety alarm device is provided that is of specific applicability to children. The personal safety alarm is integrated into a watch to be worn by a child. In one particular embodiment, the alarm can be programmed to be inactive during certain time periods determined by the time on the watch.

Other features which are considered as characteristic for the invention are set forth in the appended claims.

Although the invention is illustrated and described herein as embodied in a child safety alarm and method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

The present invention and its many features and advantages will be more apparent after reading the following detailed description which refers to the accompanying drawings illustrate the working parts of this invention. Like reference numerals refer to like items throughout the drawing.

FIG. 1A is an isometric view of a personal safety alarm device in accordance with one particular embodiment of the instant invention.

FIG. 1B is a partial plan view, taken from one side, of the personal safety alarm of FIG. 1A.

FIG. 2 is a partial view of a rear portion of a personal safety alarm device in accordance with one embodiment of the present invention.

FIG. 3 is a partial view of a back portion of a personal safety alarm device in accordance with one particular embodiment of the instant invention.

FIG. 4 is a partial schematic diagram of a circuit useful in a personal safety alarm device in accordance with one particular embodiment of the instant invention.

FIG. 5 is a partial isometric view of a personal safety alarm device in accordance with another particular embodiment of the instant invention.

FIG. 6 is an isometric exploded view of a personal safety alarm device and accessory in accordance with one particular embodiment of the instant invention.

FIG. 7 is a front plan view of a personal safety alarm device and accessory and accessory in accordance with one particular embodiment of the instant invention.

FIG. 8 is a view of another personal safety alarm system in accordance with one particular embodiment of the instant invention.

FIG. 9 is a front plan view of a personal safety alarm in accordance with another particular embodiment of the present invention.

FIG. 10 is a view of a personal safety alarm system in accordance with one particular embodiment of the instant invention.

FIG. 11 is a flow diagram of a method in accordance with one embodiment of the instant invention.

FIG. 12 is a flow diagram of another method in accordance with one embodiment of the instant invention.

FIG. 13 is an exploded partial view of a personal safety device in accordance with another embodiment of the instant invention.

FIG. 14 is a diagram of a network for using a panic alarm device in accordance with one particular embodiment of the instant invention.

### DESCRIPTION OF THE PREFERRED EMBODIMENTS

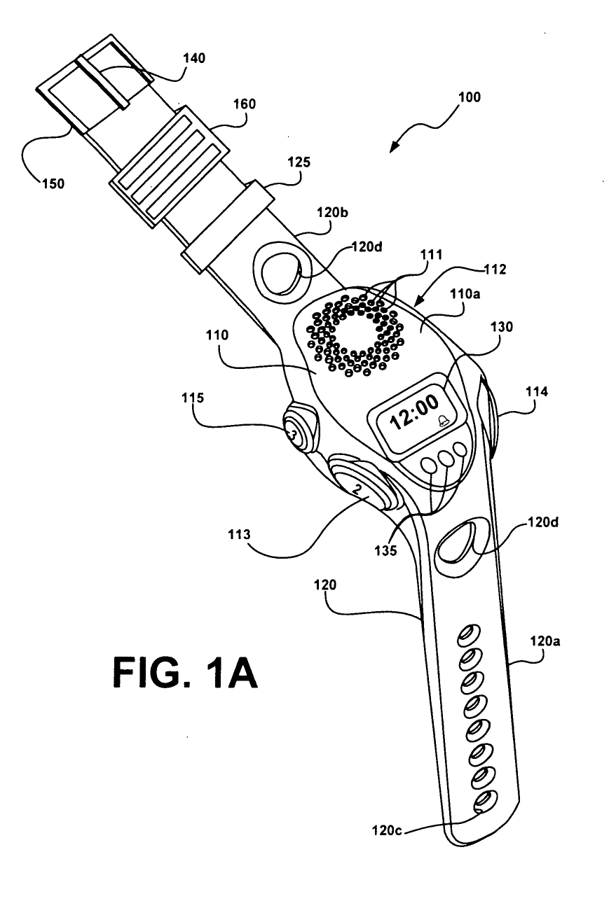

Referring now to the figures of the drawing in detail and first, particularly, to FIGS. 1A and 1B thereof, there is shown a digital watch and personal safety alarm device 100 specifically designed for children. The personal safety alarm device 100 acts as a hidden emergency panic alarm such that, in the event of an emergency, a child can easily press a preset combination of buttons to initiate a panic alarm that will initiate a very loud (i.e., high-decibel) alarm and/or flashing lights, to let everyone in the area instantly know that a child is in danger and needs help. Such a device 100 can be useful in situations where: a stranger is trying to lure the child away; a bully is antagonizing a child and the child feels uncomfortable; a child is injured (i.e., falls off its bicycle), is alone and needs help; or a child becomes separated from its parent or guardian in a crowded mall or theme park.

The safety alarm device 100 includes a watch portion 110 mounted on a strap 120. In one particular embodiment, the strap 120 is integrated with the main body of the watch portion 110, for providing additional safety. In the instant embodiment the strap 120 includes the strap portions 120a and 120b, located on, or integrated with, either side of the watch portion 110. Strap portion 120a includes holes 120c for engaging the finder 140 of the buckle 150 in a locking engagement, to secure the device 100 around the wrist of a child. Strap 120 is preferably made from a tear-resistant material, such a rubber. The strap 120 can be further reinforced to prevent cutting. In the particular embodiment, the strap 120 can optionally include an opening or openings 120d for engaging and maintaining an accessory on the strap 120.

Additionally, the safety alarm device 100 can be provided in different sizes, in order to fit the wrists of children in different age groups and/or genders. For example, if desired, a safety alarm device 100 can be provided that is sized to fit children ages 5-8, while other safety alarm devices 100 can be provided that are sized to fit children ages 9 and up.

Additionally, the watch portion 110 includes a digital display 130 for discerning the time. Note that, in the instant embodiment, an analog watch display could be provided in addition to or, instead of, the digital display 130 of the watch portion 110. Additionally, the digital display 130 could be used to display additional information, as is common for digital watches, such as date and day, and/or additional material, as will be discussed below.

The watch portion 110 additionally includes on the front face 110a thereof, sound holes 111 through which sound from an underlying speaker, such as from a piezo-horn. As part of the special alarm features of the personal safety alarm device 100, the watch portion 110 includes on the face thereof, three bright lamps or LEDs 135 for signaling an alarm condition when the personal safety device 100 is actuated in that mode. Note that more or fewer alarm lights 135 can be used. Additionally, in one preferred embodiment, three bright red LEDs located on the front face 110a of the watch portion 110, upon initiation of the panic alarm, will be strobed. Such lights 135 are visible in varying light conditions and, in addition to the alarm emitted by a sound generating device, provides another way to help locate the child. Additionally, lights 135 can be pulsed in a predetermined sequence, such as an SOS signal sequence. Further, in one particular embodiment of the instant invention, the device 100 can be programmed so as to pulse the lights 135 in an emergency mode, in response to the entry of a particular activation sequence, without the audible alarm being activated.

Additionally, the watch portion 110 includes a plurality of buttons 112, 113, 114 and 115, the actuation of which initiates different functions of the personal safety alarm 100. For example, the button 112 may be used to enter the “time set” mode, while the buttons 113 and 115 can be used to actually set the time and other watch functions of the device 100. Additionally, as an example, the button 115 may be used to activate a light that illuminates the backlit display 130.

In one particular embodiment of the present invention, in order to activate the panic alarm of the personal safety alarm device 100, two buttons, most preferably on opposite sides of the device 100, are simultaneously pressed. For example, simultaneously pressing buttons 113 and 114 will activate the panic alarm in one particular embodiment of the present invention. Pressing the buttons 113 and 114 individually may initiate different functions of the device 100, such as selecting a mode or starting a stopwatch. However, it is believed that requiring two buttons on opposite sides of the device 100 to be pressed provides more security against accidental initiation than initiating a panic alarm from only a single button. Additionally, in the instant embodiment, the button 112 of the watch portion 110 is a recessed pinhole button switch 112, generally requiring a tool for activation. For example, depression of the pinhole button switch 112 by a pin-like tool can be used to reset the alarm system and/or the watch programming, as desired.

Note that, although three push buttons 113-115 and one pinhole button switch 112 are shown, this is not meant to limit the present invention. More particularly, a greater number or lesser number of buttons can be provided, as desired, and still be in accordance with the present invention. However, in the most preferred embodiment, at least two buttons are provided, one on each side of the device 100, the simultaneous pressing of which activates the panic alarm of the device 100.

The personal safety alarm 100 is engaged with the wrist of a child, as with other watches. However, in the particular embodiment of FIG. 1A, a security keeper 160 is included on the strap 120, in addition to a standard watchstrap keeper 125. The security keeper 160 is designed to slide over the buckle 150 and finder 140, while the finder is engaged in one of the holes 120c.

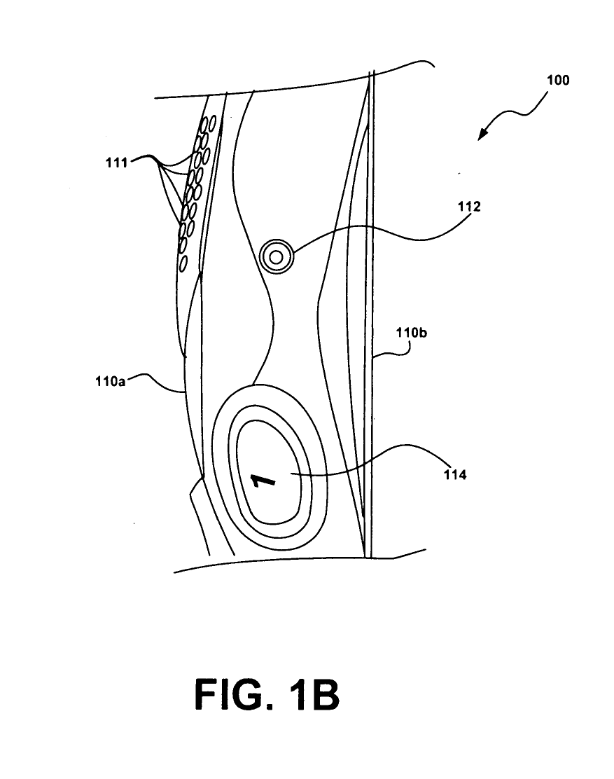

FIG. 2 demonstrates the ability of the security keeper 160 to be slid in the direction of the arrow to cover and encompass within the security keeper 160, the buckle 150. Although not shown in FIG. 2, when the finder 140 of the buckle 150 is engaged through one of the holes 120c, the free end of the strap 120a can be slipped through both the security keeper 160 and the standard keeper 125, after which, the security keeper 160 is slid in the direction of the arrow of FIG. 2, to cover and encompass the buckle 150, the finder 140 and the section of the band 120a engaged with the tang 140.

As such, the personal safety device 100 cannot be unbuckled easily or quickly. For example, once the personal safety device 100 is activated and the alarm is sounding, it will be difficult for an attacker to focus on, and figure out how, to disengage the keeper, finder and buckle arrangement, and thus, it will be difficult for an attacker to remove the watch from the wrist of the child.

Note that, although a buckle having a tang type finder 140 is shown, it is understood that the buckle 150 and hole 120c arrangement can be replaced by a folding deployment clasp and mating latch system, as is known in connection with metal watch bands, and still be in keeping with the instant invention. In such an embodiment, the standard keeper 125 and holes 120c would be omitted. However a security keeper 160 could still be provided on either the strap portion 120a or 120b, such that the security keeper 160 could be slid over the mated deployment clasp and latch, to make it difficult for the clasp to be disengaged while the device 100 is on the wrist of a child.

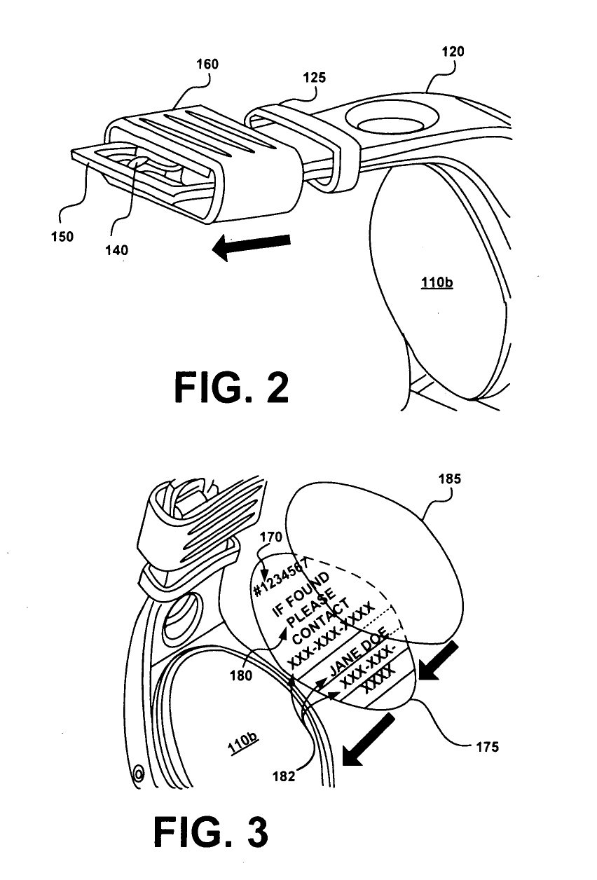

In the event that the personal safety device 100 is successfully removed from the child's wrist, the personal safety device 100 of the instant preferred embodiment can be provided with markings and/or instructions that can be used by a bystander who finds the watch, to alert the authorities. Referring now to FIG. 3, there is shown one particular emb [symbol] back portion 110b of the watch portion 110 of the personal safety device 100. The back portion 110b of the personal safety device 100 can include information thereon to permit identification of the device 100. For example, a serial number 170 can be provided, by which each particular personal safety device can be individually identified. In one particular embodiment, the serial number 170 (as well as emergency contact information, such as a telephone number) can be etched, embossed, or otherwise printed, directly on the metal or plastic plate on the back portion 110b of the watch portion 110. Alternately, as shown in FIG. 3, the serial number 170 can be provided or written on an adhesive label or decal 175, to be located on the back portion 110b of the device 100. A product registration card marked with the individual serial number 170 can be provided with the device 100, such that a parent can register the product online, by mail or by telephone, providing the information necessary for identifying the child and/or contacting the parent in the event the child is separated from the watch. Such information can additionally be updated online, by mail and/or by telephone, from time to time.

The back of the watch portion 110 may further include a statement 130 [symbol] that a [symbol] immeditel [symbol] [symbol] other information [symbol] 175 is used, such a decal 175 can be filled out and [symbol] to the back portion 110b of the watch [symbol] 110. Additionally, contact information can [symbol] ces 182 decal to provide an adults contact information, such that in the event that a child gets separated from the safety device 100, the individual who finds the safety device 100 will know whom to contact and/or whether to call the police. Such an adhesive decal can be filled out, using a ball point pen, to provide emergency contact information and phone numbers. Once completed, the decal is affixed to the back 110b of the safety device 100. A clear protective cover 185 can be provided that adheres to the non-adhesive face of the decal, for placement over the decal, to insure that the information written on the decal will not rub off with normal usage.

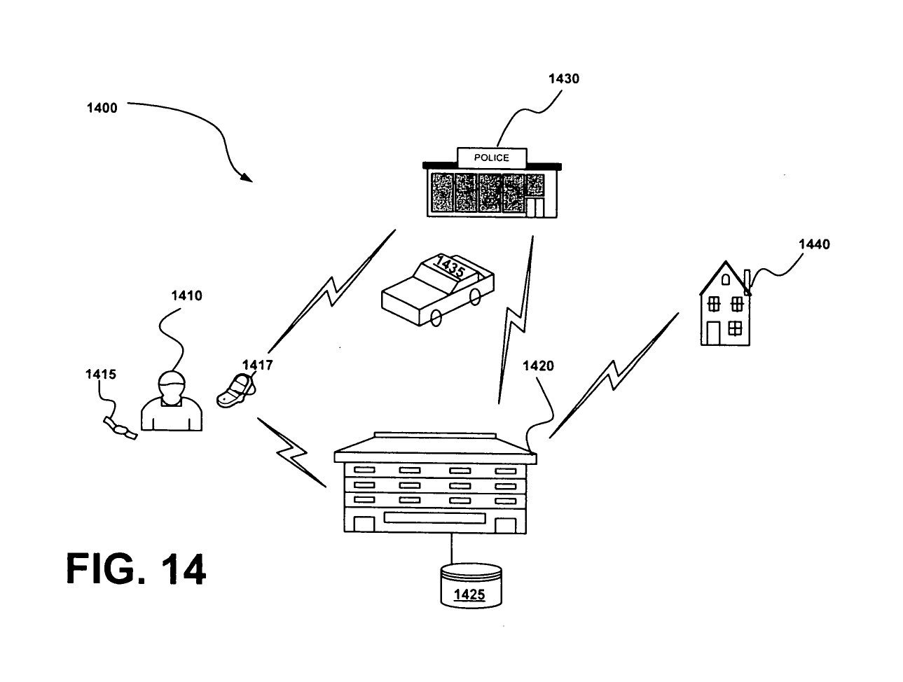

Further, referring now to FIG. 14, as an alternative to providing the contact information of a parent or the police, the decal (175 of FIG. 3) of the alarm device 1415 can provide a finder 1410 with an emergency telephone number that, when called, will connect the caller to a central call center 1420 with information about the child obtained through the registration process. The finder 1410, upon finding the alarm device and calling the emergency telephone number (i.e., using the finder's cellular telephone 1417), may be asked to report the serial number 170 of the watch and the time, date and location where the alarm device 1415 was found. The central call center 1420, using the serial number (170 of FIG. 3) and file information on the child can initiate a search for the child, by calling the parents, guardian or school (collectively shown as 1440 in FIG. 14) and/or police 1430, based on emergency contact information entered into the database 1425 of the call center for each particular child. Additionally, in response to the call from the call center 1410, a police officer (in car 1435) can be dispatched to look for the individual associated with a particular device 100. Further, an individual, such as a security guard or detective who is employed by the call center can be dispatched by the call center 1410. Alternately, the police 1430 can be called directly by the finder 1410, and through access to the database 1425 acquired from the registration information for the device, can initiate a search for the child associated with a particular device. Participation in the call center system 1400 can be included as part of the purchase of the watch, or through payment of a monthly subscription fee.

Further, the logic of the watch can be programmed to display alarm messages on the display 130 of the device 100 of FIG. 1A. For example, in alarm mode, the display 130 can inform the viewer to “SEE BACKSIDE”, in order to signal the finder to look at the back of the watch. Alternatively, during alarm mode, the serial number of the watch and/or a telephone number to call and/or some other message can be displayed on the watch display 130.

The personal safety alarm device 100 may be designed in different appropriate colors and designs to appeal to children. Further, the outward appearance of the personal safety alarm 100 will appear to others as a watch, thus masking the personal safety alarm feature of the device 100. Optionally, the device 100 may be provided with interchangeable faceplates, so that the child can personalize the watch and make it more fun for them, personally, to wear.

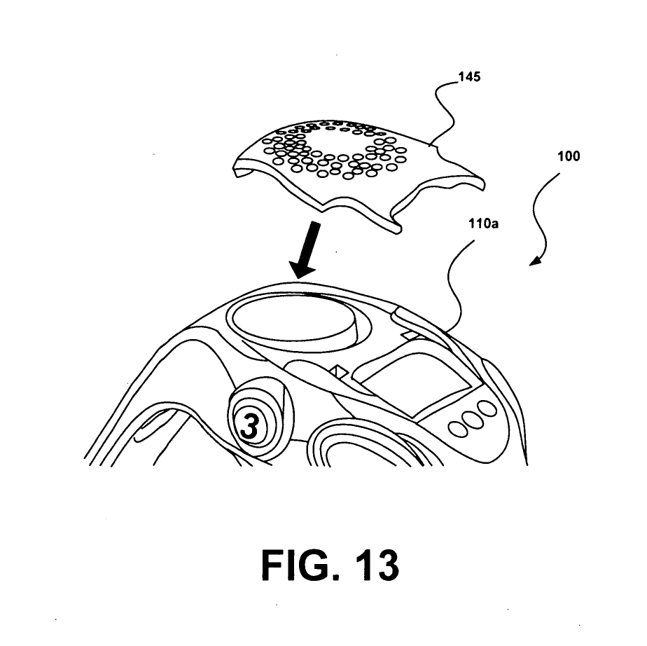

Referring now to FIG. 13, a variety of faceplates 145 for the front portion 110a of the device 100 can be provided with the device 100 or sold separately, including a variety of different themes and colors, so that there is something to appeal to every child. The faceplates 145 can be easily removed and changed by the child, without exposing any of the watch components, for safety and security reasons.

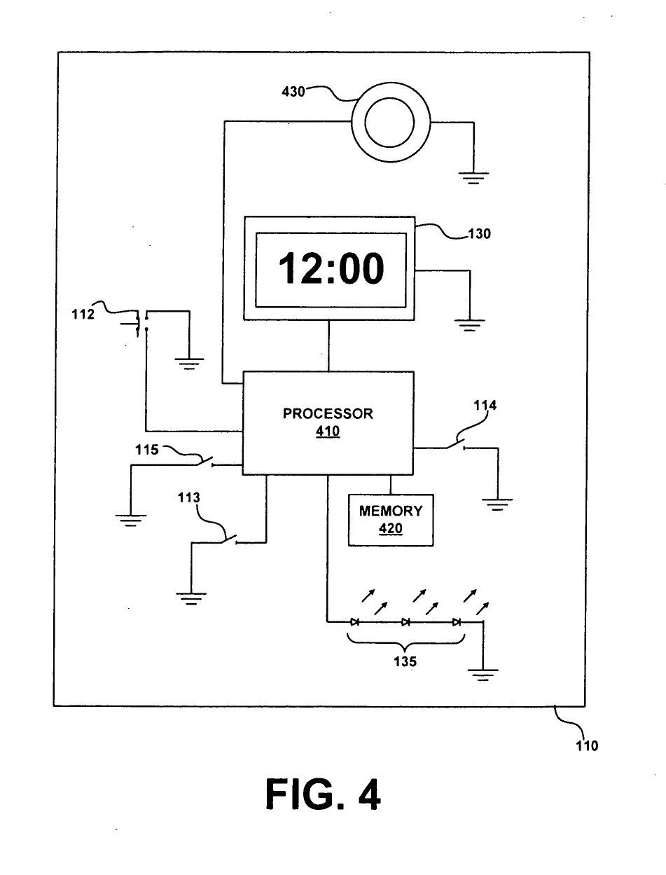

The operation of the watch portion 110 is controlled by hardware and/or software. Referring now to FIG. 4 there is shown a schematic diagram of one particular embodiment of the underlying system for the watch portion 110. The functionality of the watch portion 110 are controlled by a processor 410 and programming (i.e., firmware) stored therein. The processor 410 maintains and controls the display 130 and the accurate display of the time thereon, based on clock signals generated using an oscillator (not shown). Additionally the processor receives inputs from the pinhole button switch 112, as well as the function switches 113, 114 and 115. For example, in one particular embodiment of the instant invention, the processor 410, upon sensing the simultaneous closure of the switches 113 and 114 (located on opposite sides of the watch portion 110) will initiate an alarm routine. Such alarm routine may cause the processor 410 to actuate a sound generating device 430 and/or to light and/or strobe the LEDs 135. The sound generating device 430 of the instant invention can be any type of sound generating device that issues a loud and/or shrill alarm tone (i.e., a piezo-horn, air-horn, digital synthesizer, etc.). In the instant embodiment, the sound generating device 430 is a piezo-horn which emits a very loud, high decibel (i.e., between around 100-120 db) alarm tone. Such a device 430 can be heard for a distance of, for example, 400 feet, subject to environmental factors. Note that various decibel levels of alarm tones can be used. For example, 110-115 decibels is one preferred range for the alarm tone.

Additionally, the watch portion 110 can include programmable memory 420 (i.e., such as flash memory) in which data relating to particular programming of the device can be entered. For example, in accordance with one particular embodiment of the instant invention, the personal safety alarm 100 can be programmed by a user to provide certain functionality. User selected data for the particular functions can be stored in the memory 420, which can be a flash RAM or other writable memory device, for use by the processor 410.

Black-Out Periods:

Additionally, in one embodiment of the instant invention, the personal safety alarm 100 can be programmed by a parent or guardian to be inactive during certain time periods (i.e., “black-out” or “silent” periods) determined by the time on the watch portion 110.

More particularly, parents, or other programmers of the device, can easily pre-set defined times and/or dates, using the display 130 and buttons 112-115, in which the panic alarm of the device 100 is disabled. For example, the panic alarm may be deactivated or “blacked out” at times when the parents know that a child will be in a safe environment (i.e., five minutes before the start of the child's first class of the day). The panic alarm will be, automatically, rearmed/reactivated at the programmed end of a “black-out period” (i.e., fifteen minutes before the end of the school day). The user entered start and stop times for black-out periods will be stored in the memory 420. Memory 420 can include a plurality of memory slots so that a plurality of black-out periods can be set. Note that the black-out periods take effect based on the current time and date, as kept on the watch portion of the device 110. As such, if desired, the device 100 may require entry of a parental code, using the buttons 113-115 and/or display (i.e., wherein buttons 113, 114 and/or 115 can be used to select base 10 numbers of a code on the display or wherein a particular button sequence is entered), in order to restrict access to the programming portions of the device 100. Requiring entry of a parental code can restrict access to the stored blackout period times, as well as to the setting of the time and day within the watch portion 110, to ensure that a child does not change the programming of the device 100, in order to get around the programmed black-out periods.

Further, programmed black-out periods can be set up in different combinations. For example, firmware may permit the black-out periods to be set for an individual day, for the same day every week, for the same time during each weekday, or only on weekend days, among other options.

While in black-out mode, a symbol or icon representing the black-out or silent mode, can be displayed on the display of the watch portion 110, to indicate that the device 100 is in a black-out mode.

Reminder Alarm:

The programming of the watch portion 110 can be set to issue reminder alarms for the child. For example, reminder alerts can be set to notify children that it is time to come home for dinner, or time to do their homework. Such a reminder alert can remind a child of a predefined event in the case where the child has simply lost track of time. Reminder alarm times and events can additionally be stored in the memory 420. At the preset time, the reminder is triggered and a reminder alarm will be sounded for a predetermined time. In one particular embodiment, once triggered the reminder alarm will cause the device to emit a repeating 3 second long chirp, which sounds very different from the emergency alarm. The reminder alarm, once sounded, can be silenced by a designated button on the safety device.

Once a reminder has been set, a reminder symbol or icon can be displayed on the display of the watch portion 110, to indicate that the device 100 has been programmed with a reminder alarm.

Alarm Disarming Code:

In connection with the panic alarm programming of the personal safety alarm device 100, the parents or guardian can set a secret code that they share with the child that can be used to de-activate the panic alarm. The “secret code” utilizes a combination of the buttons 113-115. Such code will, once set, additionally be stored in the memory 420. Alternatively, the device 100 may come preset with a unique alarm disarming code, which upon reporting the serial number via telephone, may be provided to the finder of the watch. Such disarming code may be permanent, or may be reset by the user to a user recognized code which is stored in memory.

Alternately, in one particular embodiment of the present invention, the secret code is any four digit combination of the three buttons 113, 114 and 115. The secret code can be set into the device 100 by pressing the set button repeatedly, until the display shows a particular sequence indicative of the code setting mode. In one particular example, the display will shown four “+” signs (i.e., “++++”) to indicate that the user should enter the secret code, using the buttons 113-115. Each of the buttons 113-115 used in the secret code are pressed, in the desired sequence, to set the code. In one particular example, the button 113 is pressed for the number 1, the button 114 is pressed for the number 2 and the button 115 is pressed for the number 3. The secret code can then be entered as a four-digit combination of the numbers 1, 2 and 3, using the buttons 113-115, in a particular combination.

For example, to set the secret code to be “1312”, the buttons would be pressed in the following order: 113, 115, 113, 114. Note that, in the particular embodiment of FIG. 1, each of the buttons 113-115 is embossed with a button number 1-3, respectively, to assist both the child and the parent in remembering the secret code button sequence. Alternately, if desired each of the buttons could be embossed with a letter or other type of symbol (for example, “ [symbol] ”, “ [symbol] ” and “ [symbol] ”). In the present example, once set, the alarm can be disabled and/or the device reprogrammed only by pushing the buttons 113-115 in the following order: 113, 115, 113, 114 (i.e., physically embossed with button numbers “1”, “3”, “1” and “2”, respectively).

While setting the secret code, the display on the device 100 will show the corresponding button “number” on the screen, as each button in the sequence is selected. Additionally, once a number is selected for one of the four-digit fields, the cursor shown on the display will automatically be advanced to the next field. In one particular embodiment, once all four-digit fields have been filled, the display will ask the user to press the set button to confirm the desired secret code. Optionally, in the event that the secret code is lost or forgotten, the device 100 could be provided with a fixed override code, for example, holding the set button 112 and a particular one of the buttons 113-115 for a predetermined period of time (i.e., 15 seconds), to permit a new secret code to be set. However, the fixed override code will be disabled while the emergency alarm is activated, so that the secret code cannot be reset at that time.

Optionally, in the event that the panic alarm is activated unintentionally and the disarming code is not forthcoming, the panic alarm may be reset by locating the small opening giving access to the recessed pinhole button switch 112 and using a fine tool, such as a pin or paperclip tip, to depress the button switch 112 for a predetermined period of time, such as three seconds. The pinhole button switch 112 is provided to disarm the panic alarm given the belief that an attacker will not know to locate the button, will not be able to locate the button quickly and while the alarm is going off without the cooperation of the child, and/or will not have available on hand the necessary tool with which to depress the button, even if the pinhole could be located and reliably accessed for the required period of time. Depressing the pinhole button switch 112 may be used to only disarm the panic alarm, or may additionally be used to reset the memory 420, if desired. In a case where the device is completely reset a default disarming code may be preprogrammed in the firmware and/or other permanent memory of the processor 410. After the secret code has been set, it can be used to stop the emergency alarm once it has been activated. To stop the emergency alarm while it is sounding, the secret code is entered by pressing the buttons of the watch portion 110 in the correct sequence. If the code is correct, the emergency alarm will stop sounding. If the code is incorrect, or if the code is not entered, the emergency alarm will continue to sound. In one particular embodiment of the invention, the emergency alarm will sound for a predetermined amount of time, for example, for five minutes, before automatically shutting itself off. Alternately, if desired, the emergency alarm can be allowed to sound indefinitely, until the code is entered, the pinhole switch is activated or the battery is depleted.

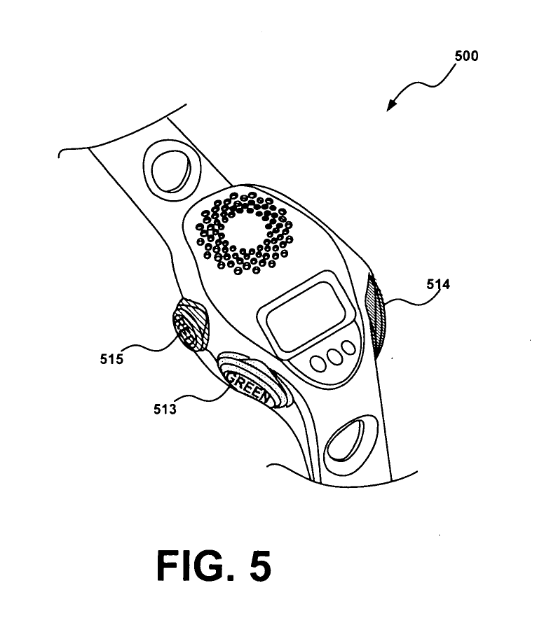

Additionally, referring now to FIG. 5 there is shown one particular example of another personal safety alarm device 500 in accordance with the instant invention. The personal safety alarm device 500 is identical in all respects to that of the personal safety alarm device 100, except that the buttons 513-515, corresponding functionally to the buttons 113-115, are each a different color, cosmetically, as denoted by the different stipling of the buttons 513-515 in FIG. 5. For example, as shown in FIG. 5, button switch 513 is selected to be green, while button switch 515 is red. Button switch 514 can be selected to be a third color, different from the colors of buttons 513 and 515, such as yellow or blue. However, the particular colors assigned to the particular buttons in the present example is not meant to be limiting, as, in the instant embodiment, any of the buttons 513-515 can be of any color. It is only preferred, in the instant embodiment, that each color chosen for each of the buttons 513-515 be different from each other chosen color. Additionally, although marked with the colors in FIG. 5, for demonstrative purposes only, the buttons of the device 500, in practical use, will not be embossed with the name of the colors, but, in all likelihood, can be embossed with the button “numbers”, in the same fashion as shown in connection with FIGS. 1A and 1B.

In the embodiment of FIG. 5, once the alarm disarming code is set and stored in the memory (420 of FIG. 4), it can be taught to a child as a sequence of colors and numbers, if the buttons are embossed with numbers, as opposed to a sequence of generic looking buttons. For example, the child may be taught that, in order to disarm the panic alarm, they could press red, red, blue, blue. Providing such unique identifiers, such as colors and numbers, on the buttons themselves, would be more helpful in getting a child to remember the disarming code, in the event that the child is relied upon to disarm an erroneously activated panic alarm. Note that the length of the disarming code, as well as the code itself, may be preset in the device 500 or may be set by the person programming the device 500.

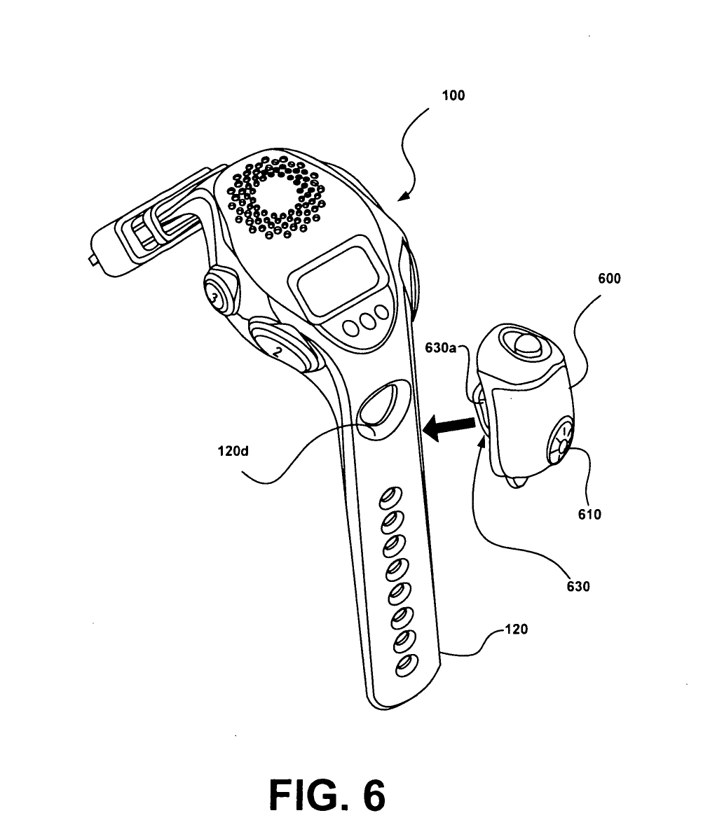

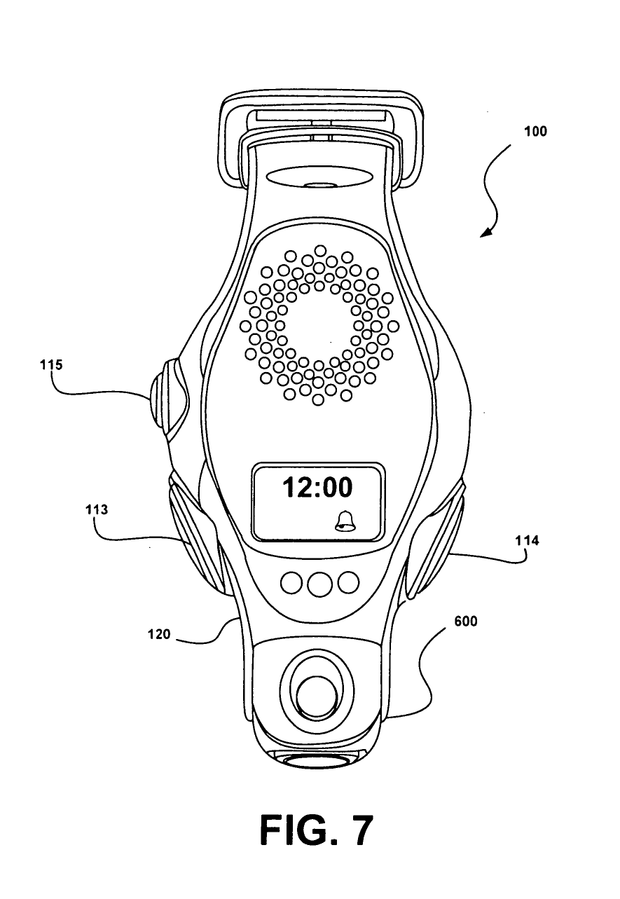

Referring now to FIGS. 6 and 7, there is shown the personal safety alarm device 100 being used with a removable accessory 600. The accessory 600 includes a post 630 that can be engaged with the accessory hole 120d of the strap 120. The post 630 on the accessory 600 includes a base portion 630a that, when the post 630 is snapped into the accessory hole 120d, maintains the accessory 600 on the strap 120. In the instant embodiment, the accessory 600 is a flashlight including an LED or lamp 620 activated by a pushbutton 610. However, any number of accessories may be used with the personal safety device 100. For example, certain wireless accessories can be used with the device 100. In one embodiment, a walkie-talkie module can be provided as an accessory, including a wireless transceiver, which can be used as a walkie-talkie with other walkie-talkie modules held by other children, or by adults wishing to communicate with the children. Such a walkie-talkie module accessory can transmit and receive using radio signals, cellular signals and/or other wireless protocols, such as BLUETOOTH. Preferably, a powered accessory 600 will include its own battery or power source, to prevent the use of the accessory from depleting the power supply to the safety device 100. Additionally, non-powered accessories can be mated and engaged with the device 100. For example, a compass, such as is used by the Boy Scouts and other orienteers/campers, could be adapted for use as an accessory to be engaged with the device 100. Similarly, other articles, including containers of lip-gloss, pill boxes, candy holders, etc., can be adapted to accessories that can be removably engaged with the device 100 and frictionally maintained in such engagement.

Another possible accessory for the device 100 is a microphone transmitter, which can be used by a remote receiver to listen in remotely at the location of the device 100. Similarly, a receiver module, only, may be included which would receive signals from a remote transmitter, such as held by a parent, in order to transmit voice reminders to the child. Further, the accessory 600 could include a miniature camera transmitter, similar to those known as a “spy-cam” or “nanny-cam” to process and transmit to remote location, video taken from adjacent the device 100.

Alternately, the device 100 could include, built therein, a transmitter or receiver to transmit and/or receive radio and/or cellular signals from the device 100. For example, in one particular embodiment, the device 100 includes a cellular modem, such that when the panic alarm is activated, the device 100 automatically calls an emergency number and transmits a packet of data individually identifying the device 100. Further, the device 100 can include means for providing location information remotely, such as through the use of a GPS transmitter and/or cellular triangulation. Such geographic information can additionally be provided from the device to a remote location using a radio and/or cellular transmitter with VoIP or SIP capability.

As such, it should be understood that information can be transmitted to the device 100, itself, from a remote device and/or information from the device 100, itself, can be transmitted to a remote device. For example, in addition to the above-described embodiments utilizing a communicative accessory 600, the device 100 could be adapted to communicate to and/or from a remote device without such an accessory. For example, the device 100 could be programmed to include information about a preset perimeter, wherein the device 100 activates and/or sends a signal to a remote device, if it is detected that the child has gone beyond the boundary of the preset perimeter. In such a case, the device 100 would include additional circuitry (for example, GPS and/or RF detection circuitry) to assist the device in making the determination that the child has left the perimeter.

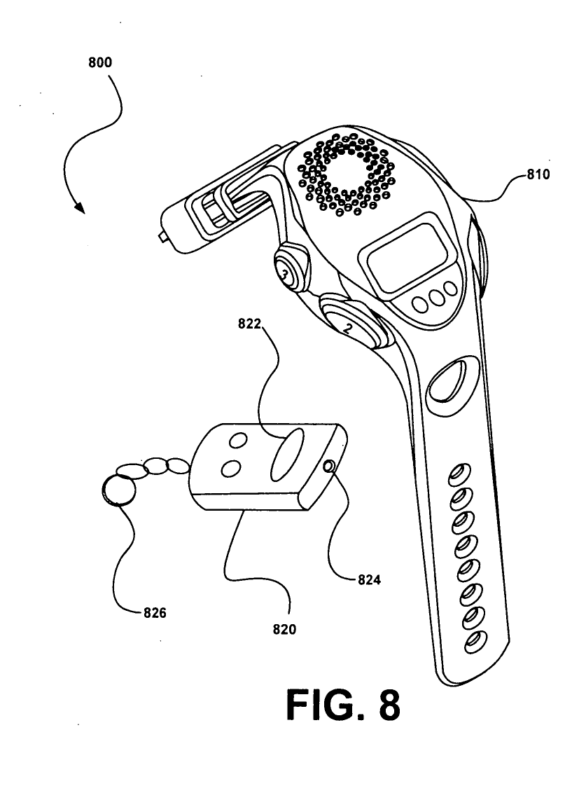

Additionally, in an alternate embodiment, such as that shown in FIG. 8, there is provided a personal safety system 800 including a personal safety alarm device 810 and a portable transmitter device 820. The portable transmitter device 820 is a transmitter device of the kind often used to remotely unlock the doors of cars, and may even be integrated into a transmitter device used for that purpose. In the instant embodiment, the personal safety alarm device 810 includes a receiver for receiving signals from the portable transmitter device 820. Upon actuation of a button 822, the portable transmitter device 820 sends a signal to the personal alarm device 810 that remotely activates, and/or controls, the panic alarm of the device 810. In one preferred embodiment, the portable transmitter 820 uses RF to communicate with the device 810. This is not meant to be limiting, as other transmitters, such as Bluetooth, can be used. Preferably, the transmitter will have a range of about 200 feet. The transmitted signal from the transmitter 820 would be coded to a corresponding device 810, such that actuation of the device in a public place will result in only the desired personal safety alarm 810 being activated and/or deactivated. Additionally, if desired, the personal safety device 810 can be programmed and/or defined such that actuation of the remote transmitter 820 will activate the personal safety alarm device 810, even when the personal safety alarm device 810 is in a pre-set black-out period. Alternately, if desired, the personal safety alarm device 810 can be programmed and/or defined so as to not be activated by the transmitter 820 if the personal safety device 810 is in a pre-set black-out period.

Further, optionally, the portable transmitter device 820 can include other functionality, like a built-in flashlight 824 and/or keychain 826. Optionally, the portable transmitter device 820 could be incorporated into a portable USB flash drive, or other small handheld device. In one particular embodiment, a USB flash drive/memory incorporated with the portable transmitter device 820 can carried with the adult and contain the information needed by the authorities for locating and/or identifying the child (i.e., height, weight, recent photo, fingerprint, home address, etc.). This information can then be downloaded and quickly disseminated by the police.

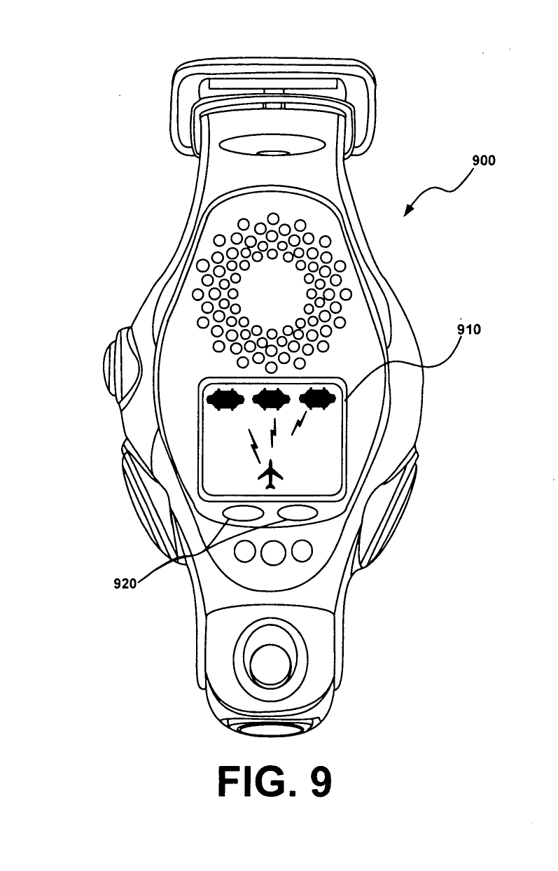

Referring now to FIG. 9, there is shown another embodiment of a personal safety alarm device 900 that is designed to appeal to children. The device 900 includes a larger display 910 and, optionally, additional buttons 920. As such, the device 900 can additionally be used for further purposes that attract the child to the device 900. For example, video game functionality can be incorporated into the device 900. Further, the device 900 could include an MP3 or other type of music and/or video player that would appeal to children, thus ensuring that the children want to wear the device 900.

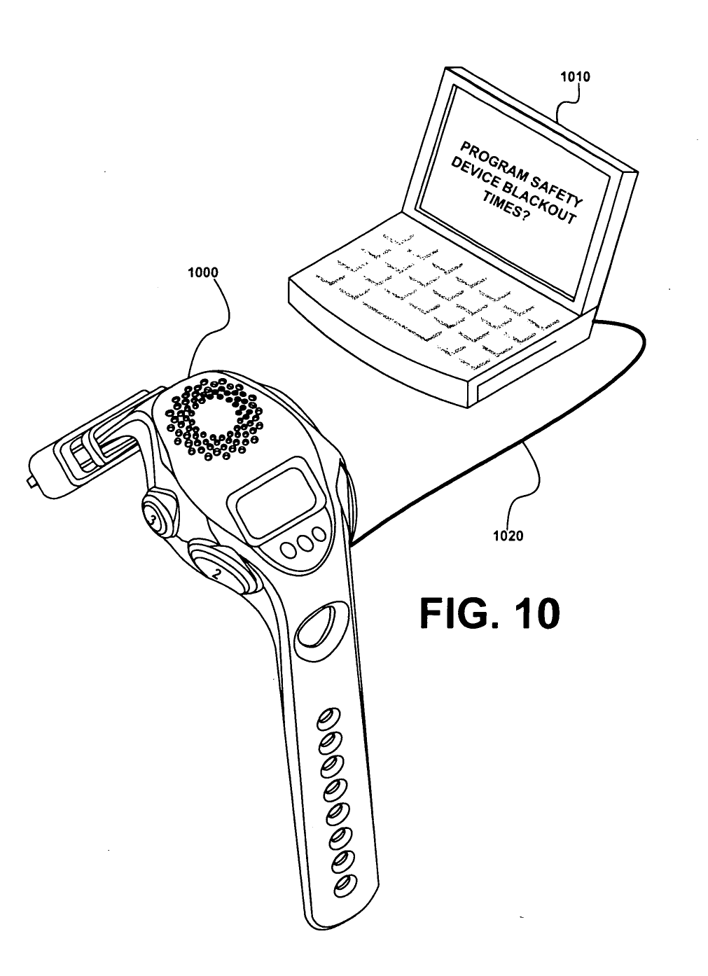

Further, referring to FIG. 10, there is shown a personal safety alarm device 1000, which may be of the types previously disclosed, further including a port or other connector (such as a USB port) that enables the device 1000 to be interfaced to a computer 1010, via a connector cable 1020. Alternately, or in addition thereto, if the device 1000 has wireless capabilities, such as IR, RF and/or BLUETOOTH™, the device 1000 can interface with a computer 1010, wirelessly (i.e., without the cable 1020). The device 1000 can be packaged with software that enables the programmer to program the device 1000 via an interface on the computer 1010. For example, black-out periods, reminder alarms and/or disarming codes can be easily programmed into the device 1000, using the computer 1010. Such black-out periods, reminder alarms and/or disarming codes are then backed-up in the memory of the computer 1010 such that, if the device 1000 loses this user programming, redocking the device 1000 with the computer 1010 can be used to restore the programming to the device 1000. Similarly, programming initiated on the device 1000 could be synched with, and stored on, the computer 1010. Further, the computer 1010 may be used to register the device 1000, online and may, further, be used to obtain firmware updates for the device 1000 over the internet.

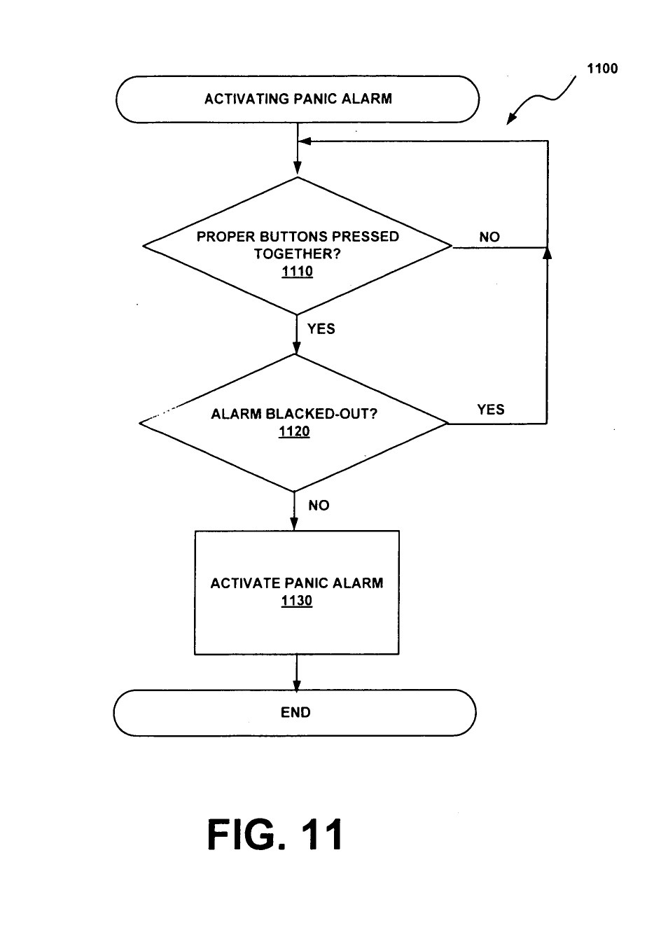

Referring now to FIG. 11, there is shown a method 1100 for activating a panic alarm using a device, such as the device 100, 500, 810 and 900. In operation, the processor of the watch portion of the device is constantly monitoring to detect whether the switches that initiate the panic alarm have been simultaneously pressed. Step 1110. For example, as described above, it is most preferred in connection with the instant invention that two buttons on opposite sides of the device 100, 500, 810, 900 be pressed simultaneously in order to activate the panic alarm. For example, in the device 100, pressing the buttons 113 and 114 simultaneously would initiate the panic alarm. If the device 100, 500, 810, 900, detects that the proper sequence is initiated (i.e., the proper two buttons are pressed simultaneously), then the processor checks its programming and memory to determine if it is presently a “black-out” period, in which the initiation of a panic alarm is not permitted. Step 1120. If a “black-out” period is in effect, a panic alarm is not initiated, and the sequence repeats. However, if the button actuation occurs at a time that is not “blacked-out”, then the panic alarm is activated. Step 1130. As stated above, in the preferred embodiment, activation of the panic mode activates a sound generating device, such as a piezo-horn or synthesizer, causing it to emit a very loud, shrill tone, and strobes the lights on the face of the device 100, 500, 810, 900. Once the panic alarm has been activated, the device 100, 500, 810, 900, stays in that mode until the device is disarmed.

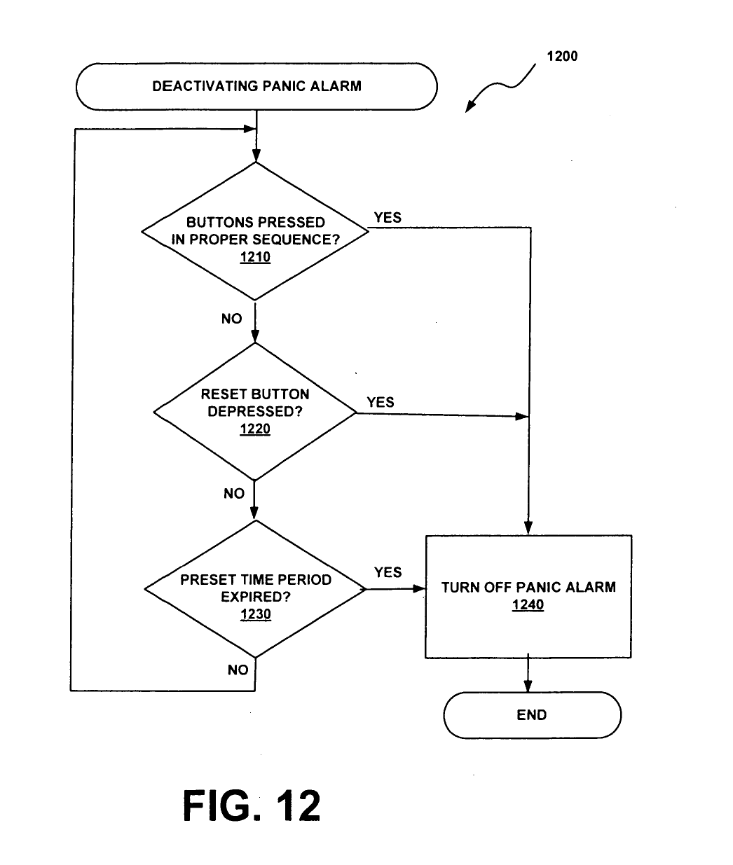

Referring now to FIG. 12, there is shown a method 1200 of disarming the device 100, 500, 810, 900, once the panic alarm has been activated. More particularly, while the panic alarm is going off (i.e., horn and lights), the processor is checking to see if the disarming code has been entered on the buttons 113-116, 513-516 (Step 1210) or if the reset/pinhole button switch 112, 512, has been depressed (Step 1220). If neither event has occurred, the panic alarm continues to be activated and the sound generating device 430 and lights 135 continue to be activated. However, if the buttons are pressed in the proper sequence (which may be represented by a sequence of colored buttons, numbered buttons, particularly located buttons, etc.) or if the reset button is depressed the panic alarm is turned off. Step 1230. If the panic button has been turned off using the disarming code (i.e., the proper sequence of buttons 113-116, 513-516) then the device 100, 500, 810, 900, is automatically rearmed, and prepared for another actuation. Depending on the particular firmware control chosen, activation of the reset/pinhole button switch 112, 512, may be designed to reset the panic alarm, only, thus rearming it for its next activation, or may reset the whole device. In the event that depression of the pinhole button switch 112. 512, resets the whole device, the device 100, 500, 810, 900, may still be armed, but may be reset to its default (original) settings.

Additionally, the personal safety alarm device 100, 500, 810, 900, of the instant invention can be sold alone, or with accessories. In one particular embodiment of the instant invention, the device 100, 500, 810, 900, is provided with an educational video (i.e., on videotape or DVD, or as a link accessible through the internet) instructing the children and their parents or guardians on the proper usage of the personal safety alarm device 100, 500, 810, 900. The educational video includes instructions that visually lead the programmer of the device through the steps for its quick setup. The educational video may additionally feature helpful tips for kids on how to remain safe in a variety of threatening scenarios.

Further, a plurality of interchangeable faceplates (for example, three faceplates) may be included with the personal safety alarm device, permitting personalization by the wearer. Additionally, snap-on accessories, such as the flashlight 600, may further be included. If desired, the device 100, 500, 810, 900, can be made to be water resistant or, in another embodiment, the device 100, 500, 810, 900 can be made to be waterproof.

A personal safety alarm device in accordance with the instant invention can provide a parent with peace of mind knowing that they have educated and empowered their child with a way to immediately signal that they need help in the event they are lost hurt, scared, threatened and/or approached by a stranger. Additionally, the parents are reassured by the fact that the child is protected by a personal safety alarm device 100 that is attractively packaged in a device that the child will want to wear, everyday, and thus, which will not accidentally become separated from the child.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A personal safety alarm device, comprising:
a watch portion including a clock and a display upon which the current clock time is displayed;
an audible alarm, integrated into said watch portion; and
a strap portion for securing the personal safety alarm device to the wrist of a user; and
said audible alarm being disabled during at least one preset time period defined by said clock.

2. The personal safety alarm device of claim 1, wherein said personal safety alarm device can be programmed to set said at least one preset time period.

3. The personal safety alarm device of claim 1, wherein said at least one preset time period is programmed into said personal safety alarm device using buttons located on the personal safety alarm device.

4. The personal safety alarm device of claim 1, wherein said at least one preset time period is programmed into said personal safety alarm device using an external programming device.

5. The personal safety alarm device of claim 2, wherein said at least one preset time period is programmed into said personal safety alarm device by storing a start time for said at least one preset time period and an end time for said at least one preset time period in said personal safety device.

6. A personal safety alarm device, comprising:
a watch portion including a clock and a display upon which the current clock time is displayed;
an alarm, integrated into said watch portion;
a plurality of buttons located on the outer housing of said watch portion, each of said plurality of buttons being uniquely marked;
a strap portion for securing the personal safety alarm device to the wrist of a user; and
said alarm being deactivated by entering a particular sequence using at least one of said plurality of buttons.

7. The personal safety alarm device of claim 6, wherein each button is uniquely marked by making each button of said plurality of buttons a different color from every other button of said plurality of buttons.

8. The personal safety alarm device of claim 6, wherein each button is uniquely marked by embossing each button of said plurality of buttons is embossed with a symbol different from the symbol embossed on every other button of said plurality of buttons.

9. The personal safety alarm device of claim 8, wherein each symbol is a number.

10. The personal safety alarm device of claim 6, wherein said alarm includes an audible alarm.

11. The personal safety alarm device of claim 6, wherein said alarm includes a visual indicator.

12. A personal safety alarm device, comprising:
a watch portion including a clock and a display upon which the current clock time is displayed;
an alarm, integrated into said watch portion;
first and second strap portions for securing the personal safety alarm device to the wrist of a user, said watch portion in communication with said first and second strap portions;
a locking mechanism for connectable between said first strap portion and said second strap portion to secure the personal safety alarm device to the wrist of the user; and
a safety keeper located on at least a portion of one of said first strap portion and said second strap portion, said safety keeper slidable over said locking mechanism when said locking mechanism is engaged to deter removal of the personal safety alarm device.

13. The personal safety alarm device of claim 12, wherein said locking mechanism includes a buckle and a finder located on said first strap portion, said finder being engaged with at least a portion of said second strap portion to secure the personal safety alarm device to the wrist of the user, said safety keeper slidable over said buckle and said finder.

14. A personal safety alarm device, comprising:
a watch portion including a clock and a display upon which the current clock time is displayed;
an alarm, integrated into said watch portion, said alarm being actuable by said user on an emergency basis;
a strap portion for securing the personal safety alarm device to the wrist of a user;
said display being disposed on the front of said watch portion; and
emergency contact information being located on the back of said watch portion.

15. The personal safety alarm device of claim 14, wherein said emergency contact information is located on an adhesive decal adhered to the back of said watch portion.

16. The personal safety alarm device of claim 15, further including a clear protective sheet adhered the non-adhesive surface of said adhesive decal.

17. A personal safety alarm device, comprising:
a watch portion including a clock and a display upon which the current clock time is displayed;
an alarm, integrated into said watch portion, said alarm being actuable by said user on an emergency basis;
a strap portion for securing the personal safety alarm device to the wrist of a user; and
said display being disposed on the front of said watch portion; and
a removable faceplate additionally being located on the front of said watch portion.

18. The personal safety alarm system of claim 17, wherein said personal safety alarm device includes a plurality of removable faceplates, each of said plurality of removable faceplates being individually engageable with the front of said watch portion

19. A personal safety alarm device, comprising:
a watch portion including a clock and a display upon which the current clock time is displayed;
an alarm, integrated into said watch portion, said alarm including at least one light source, wherein activation of said alarm causes said at least one light source to blink in a recognizable pattern;
a plurality of buttons located on the outer housing of said watch portion;
a strap portion for securing the personal safety alarm device to the wrist of a user; and
said alarm being deactivated by entering a particular sequence using at least one of said plurality of buttons.

20. The personal safety alarm device of claim 19, wherein said recognizable pattern is the Morse code pattern for SOS.

21. The personal safety alarm device of claim 20, wherein said alarm further includes an audible alarm.

22. A method of providing assistance, comprising:
providing a personal safety alarm device including:
a watch portion including a clock and a display upon which the current clock time is displayed;
an alarm, integrated into the watch portion, the alarm being actuable by the user on an emergency basis;
a strap portion for securing the personal safety alarm device to the wrist of a user; and
the display being disposed on the front of the watch portion; and
emergency contact information being located on the back of the watch portion, the emergency contact information including the telephone number of a call center and identifying information for the personal safety alarm device;
maintaining a database at the call center correlating the identifying information for a particular personal safety alarm device with a designated user of that particular personal safety alarm device;
receiving a telephone call at the call center pertaining to a particular personal safety alarm device; and
in response to a telephone call received at the call center about a particular personal safety alarm device, providing assistance on behalf of the designated user of the particular personal safety alarm device.

23. The method of providing assistance, of claim 22, wherein said providing assistance step includes, calling the police from the call center and providing the police with information from the database about the designated user of the particular personal safety alarm device.

24. The method of providing assistance, of claim 22, wherein said providing assistance step includes, calling a further emergency contact, from the call center, the information of the further emergency contact being located in the database.

25. The personal safety alarm device of claim 1, wherein said audible alarm can be activated by a remote device.

26. A personal safety alarm device, comprising:
a watch portion including a clock and a display upon which the current clock time is displayed;
an alarm, integrated into said watch portion, said alarm being actuable by said user on an emergency basis;
a strap portion for securing the personal safety alarm device to the wrist of a user; and
said strap portion additionally including one engaging portion, removably engageable with an accessory device, so as to maintain said accessory device in contact with said strap portion.

27. The personal safety alarm device of claim 26, wherein said accessory device is a flashlight.

28. The personal safety alarm device of claim 26, wherein said engaging portion includes a hole through said strap portion and said accessory item includes a post which is placed through said hole in order to maintain said accessory device in contact with said strap portion.
